(19) United States
(12) Patent Application Publication
(10) Pub. No.: US 2005/0287984 A1
(43) Pub. Date: Dec. 29, 2005

(54) Internet cellular phone prepaid service

(76) Inventor: John Quincy St.Clair, San Juan, PR (US)

Correspondence Address: JOHN ST.CLAIR, 52 KINGS COURT, 4A, SAN JUAN, PR, 00911, US

(21) Appl. No.: 10/878,199

(22) Filed: Jun. 28, 2004

(51) Int. Cl. H04M 11/00

(52) U.S. Cl. 455/406

(57) ABSTRACT

A computer utility website service that allows cellular phone cards to be purchased over the Internet.

### BRIEF DESCRIPTION OF THE INVENTION

This invention is a utility service that allows cellular phone cards to be purchased over the Internet.

### BACKGROUND OF THE INVENTION

At the present time there are only two ways that prepaid cellular phone cards can be purchased. The first method is to purchase them at a convenience store or gasoline station that sells the prepaid cards. The amount of the card is preprinted on the front of the card. The prepaid number is printed on the back of the card under a scratch-off pad. Using a special access code on the phone, such as *77 for Cingular wireless, the number is entered into the cellular phone in order to credit the user's account with the number of calling minutes corresponding to the amount paid.

The second method is to purchase the cards at a supermarket or similar outlet store that has a kiosk machine connected by modem to the store's dial-up telephone. The kiosk has a numeric keypad and liquid crystal display (LCD) for selecting the prepaid card desired from photographs displayed on the front panel. After inserting the appropriate amount of cash into the dollar bill reader, the kiosk prints out a paper receipt with the pin card number. The process proceeds as in the first method. The kiosk has a microcontroller which verifies that the amount paid is correct. It then dials the cellular phone company to obtain a proper pin number from their server computer.

There are a number of problems associated with the abovementioned methods which the inventor has personally experienced. First of all, the store may not be open which makes it impossible to obtain a card. If the store is open, they have run out of cards to purchase. If the store is open, cash might not be available for the kiosk machine because the ATM machine is out-of-order. In neighborhoods where crime is a problem, one does not feel safe parking the car on a strange side street and getting out of the car in order to walk to the store. Lastly, a store might not be available along a desolate country highway.

Maintenance is a problem with the kiosk machines. One problem is that the printer runs out of paper. Sometimes the store employees inadvertently disconnect the cable modem line when moving the phone. In other cases, the cleaning people disconnect the machine in order to plug in their vacuum cleaners, and then don't bother or remember to reconnect it.

In the last few months, more wireless technology has become available in the form of Internet-accessible portable data assistants (PDA) and wireless notebook computers. These devices allow one to connect to the Internet at any time of day or night without having to leave the car or house. Having a PDA means that the user can access a website and purchase a cellular phone pin number using a credit card, or funds from a prepaid account. Once the transaction is approved, the website server transmits the pin number over the Internet to the PDA which allows the phone caller, in a convenient and safe manner, to obtain more calling minutes.

### SUMMARY OF THE INVENTION

It is the object of this invention to create a new method for purchasing cellular phone card pin registration numbers over the Internet using wireless PDAs and portable notebook computers. The purpose of the pin registration number is to purchase more call time on the cellular phone from the cellular phone company. The call time and service fee is paid for using a credit card or prepaid funds.

The invention consists of a website computer server connected to the Internet by either a dedicated subscriber line (DSL) or wireless satellite antenna transmission (SAT) system. The DSL transmits information (voice, video, data) at high speed over existing copper telephone lines.

The main server program is programmed in Sun Micro Systems object-oriented JAVA Internet programming language. The program initiates a JAVA listener which creates a new thread for each new user accessing the website. This makes the program multi-threaded which allows more than one user to be using the system at one time. Each thread displays a convenient Windows-like environment (check boxes, pull-down menus, buttons) which allows the user to create a new membership account, or log-on to purchase a pin number.

If the user is new to the system, the program allows the user to set up a new account with full name and verified password together with the user's address, telephone number and e-mail address.

If a previously registered user is logging onto the system, the program asks for the user name and password. The program then does a database lookup to verify this information. If the information is correct, the program requests the name of the cellular phone company from a pull-down menu containing a list of companies. Two check boxes allow the user to select a payment method by credit card or with prepaid account funds.

If payment is by credit card, the program displays a pull-down menu containing a list of credit card companies, a text box for entering the credit card number, a pull-down menu for the month of expiration and a pull-down menu for the year of expiration.

If payment is by prepaid account funds, the program does a database look-up to read the account balance in the member's account. The program then displays this amount on the screen so that the user will know what level card to purchase.

The program then displays a pull-down menu showing the various prepaid card amounts from which to select. An error message is displayed if the card amount is more than the funds available. An optional feature is that the user is given a minimum credit amount with which to purchase time in case of some emergency. Otherwise, the program displays the card amount plus the service fee amount to calculate the total charge to the credit card or account. At this point the user can cancel or continue with the transaction.

If the user cancels, the program ends the JAVA listener thread and logs the user out. If the user continues with the transaction, the program connects to the credit card company to verify the transaction. If verified, the program connects to the cellular phone server to obtain the pin number which is displayed on the screen.

The novelty of this system is that the website company can purchase blocks of prepaid cards whose pin registration numbers are entered into the server's database. It is occurring more frequently that the cellular phone company's system is unavailable in which case it is not possible to obtain a pin number immediately. What this means is that if the credit card transaction is approved, and the cellular phone connection is unavailable, the program can still provide a pin number to the user from the prepaid inventory. Thus the system is always 100% successful in obtaining a pin registration number.

### A BRIEF DESCRIPTION OF THE DRAWINGS

FIG. 1. New membership window.

FIG. 2. Log-on returning membership window and payment options.

FIG. 3. Transaction approved window showing prepaid card number.

### DETAILED DESCRIPTION OF THE INVENTION

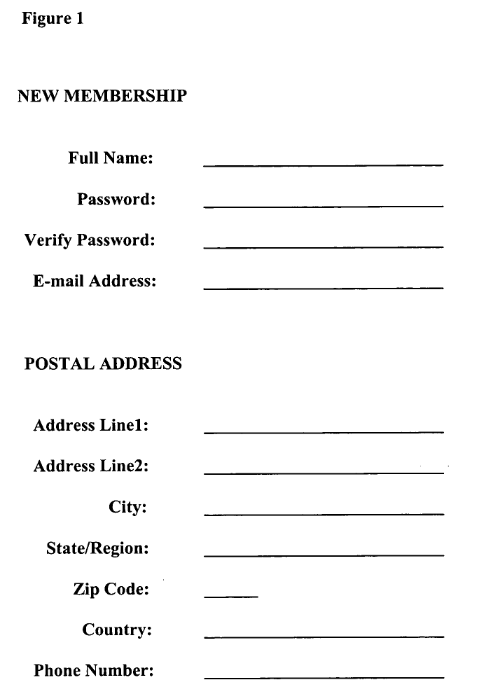

1. The new membership window is shown in FIG. 1. It contains the user's full name and mailing address together with the telephone number and e-mail address. The user enters the password and then re-enters it a second time to verify the first entry. This information is then written to the customer master file in the Oracle database server with the name and password acting as the access keyword for record look-up.

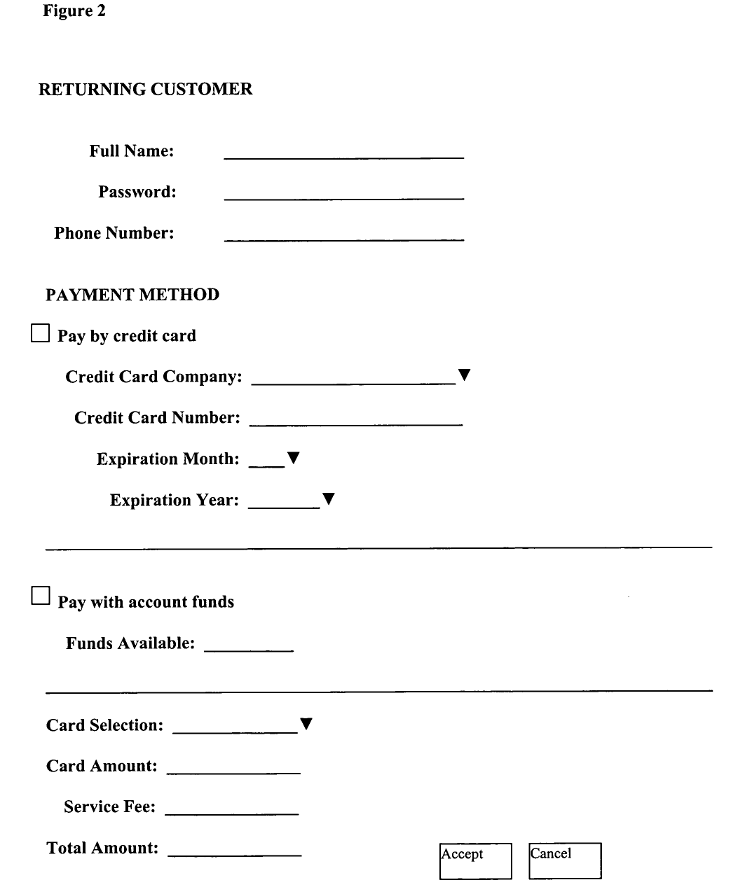

2. The returning membership window is shown in FIG. 2. The user enters the keyword consisting of the full name and password which allows the program to read the database customer master record for the phone number as well as the customer transaction file for the account balance. After the user enters the phone number, the program double checks the user's identity by comparing it to the phone number stored in the customer master file record.

3. The user then selects the method of payment by clicking on the check boxes for either pay by credit card or pay with account funds. If the method is by credit card, the user enters the name of the credit card company using a pull-down menu, the credit card number, the expiration month by pull-down menu, and the expiration year by pull-down menu (shown by the black inverted triangle).

4. If the user selects pay with account funds, the program reads through the database transaction file in order to obtain the account balance. This amount is then displayed on the screen in the Funds Available field.

5. The user then selects the appropriate prepaid card from a pull-down menu. These cards come in various denominations such as $10, $15 and $20. The program then tallies the card amount with the service fee and then displays the total charge.

6. The user then has the option of continuing with the transaction by clicking on the Accept button, or by clicking on the Cancel button. If the Cancel button is chosen, the program aborts the JAVA thread and logs out the user. If the Accept button is selected, the program proceeds to the next transaction approved screen.

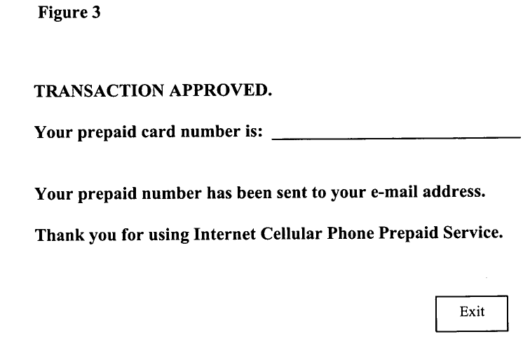

7. The Transaction Approved screen is shown in FIG. 3. This screen verifies that the transaction has been approved by displaying the prepaid card number. As an extra precaution, the prepaid number is sent to the user's e-mail address. The user can then enter this number directly into the cellular phone, or access the e-mail notification. The user then logs out by clicking on the Exit button which completes the transaction.

1. An Internet Cellular Phone Prepaid Service comprising:
a. A computer server connected to the Internet by a DSL or SAT line for the purpose of listening and responding to user requests to purchase prepaid phone calls by means of wireless portable data assistants (PDA), notebook computers and other types of Internet-connected data communications equipment such as home desktop computers;
b. A database server program written in object-oriented JAVA with multithreading capability that implements an Internet listener which allows the user to log onto the server and purchase a prepaid phone card by using a credit card or by prepaid account funds
c. An Internet communications and protocol program running on the server for connecting to the credit card company in order to verify the credit card information such as the card number and expiration date;
d. An Internet communications and protocol program running on the server for connecting to the cellular phone company in order to obtain a prepaid phone card number;
e. A database system for storing blocks of prepaid phone card numbers in case the cellular phone company's computer server is down;
f. A means by using a Windows-like environment (buttons, pull-down menus, check boxes, text entry fields) to display to the user the number of the prepaid phone card with which to obtain from the cellular phone company more calling minutes corresponding to the amount of the prepaid card.
g. An Internet communications and protocol program running on the server for e-mailing the user's account with the prepaid card number in case the user cannot record the number manually after the information is displayed on the screen.
